(19) United States
(12) Patent Application Publication
(10) Pub. No.: US 2009/0066944 A1
(43) Pub. Date: Mar. 12, 2009

(54) DEVICE AND METHOD FOR DETECTING A DEFECT IN A FINNISH RING OF A GLASS

(75) Inventors: Christophe Gauffre, Cavaillon (FR); Didier Heckmann, Salon De Provence (FR); Pierre Ollion, Le Puy Sainte Reparade (FR)

Correspondence Address: BACHMAN & LAPOINTE, P.C., 900 CHAPEL STREET, SUITE 1201, NEW HAVEN, CT, 06510, US

(73) Assignee: SAVERGLASS SAS, Feuquieres (FR)

(21) Appl. No.: 12/299,649

(22) PCT Filed: Feb. 19, 2007
(86) PCT No.: PCT/FR2007/000301

§ 371 Date: Nov. 5, 2008

(30) Foreign Application Priority Data
May 10, 2006 (FR) 06/04313

(51) Int. Cl. G01N 21/90

(52) U.S. Cl. 356/240.1

(57) ABSTRACT

A device and method for detecting a defect in a finish ring of a glass article are described. The actual position of the finish ring is measured and enables a photographic device to be accurately positioned in relation to the finish ring, whereby the optical axis of the photographic device passes through the center of the finish ring. A sample of the finish ring is made and processed via an analyzing device configured so as to automatically detect an optical signature of the defect.

### BACKGROUND

(1) Field of the Invention

The present invention relates to the field of the manufacture of glass articles, in particular operations for checking the finish ring, or finish, of an article.

(2) Prior Art

The glass articles are, for example, industrially manufactured bottles or vials. These articles generally have defects such as surface cracks (tears), blisters, lack of material, excess of material, etc., the sizes and positions of which may be random.

### SUMMARY OF THE INVENTION

More precisely, according to a first aspect, the invention relates to a method for detecting a defect in a finish of a glass article, comprising steps consisting in:
viewing an image of a sample of the finish by viewing means comprising an optical axis; and
processing the view by analysis means configured to detect an optical signature of the defect automatically.

Such a method is known to the person skilled in the art. It is, for example, employed in a certain number of checking devices or machines.

Several types of checking machine exist enabling defect detection. These machines are generally specialized and only enable detection of one type of defect.

In the course of their manufacture, the articles are placed on a conveyor and the various checks are generally carried out directly on production lines.

Among checking devices, finish checking devices are more specifically distinguished. A finish is the upper area of an article, usually equipped with a bulge, and configured in order to cooperate with closure means. Defects present in or on this area may be very small in size, which makes them difficult to detect.

Checking devices generally make use of detection systems based on video, optical and computing technology, for example, a CCD camera and a computer equipped with image processing and analysis software. So as to improve detection, particular illumination means also used. The problem is effectively to locate the defect in illumination conditions such that the defect appears more clearly or with greater contrast.

The present invention aims mainly to detect surface-crack defects. Surface cracks are one of the glass defects that cannot be eliminated in the manufacture of articles and the consequence of which is a weakening of the resistance of the article to an internal or external pressure, and/or to a tension, or again to an impact, hence a risk of breaking.

In order for the checking, i.e. the detection of defects, to be effective, the positioning of the article with reference to the checking means must be very precise so as to optimize the illumination conditions. For small-sized defects, the positioning between the article and the checking means is a predominant performance criterion.

To this end, the checking means are joined to the supporting structure of the conveyor means and comprise viewing means. The articles are often simply placed on a conveyor equipped with guiding means that are either fixed, for example rails or guides, or mobile, for example belts.

Whatever the type of guiding means, this is carried out in a different area from the area to be checked. Typically, an article generally has a base, the surface of which is greater than or equal to that of the finish, and guiding means acting on the base or the sides of the article while the checking is carried out for another area such as the finish.

Furthermore, the guiding of the articles is carried out with moving articles, and the guiding precision obtained is generally inadequate.

In addition, glass articles are, by nature, subjected to glass tolerances. These glass tolerances correspond to an axial offset of the article such that the axis of symmetry of the finish is offset in relation to the center of the base of the article, i.e. in relation to the longitudinal axis of the article. This offset may reach a millimeter and interfere severely with the detection of defects.

Moreover, depending on the type of finish used for the glass article, the detection of defects may be impossible due to the geometry of the finish on the one hand, and the random angular position of the article on the conveyor. To this end, finishes will be cited, the shape of which does not have any rotational symmetry, hereafter called threaded finishes.

The present invention, according in addition to the aforementioned preamble, has the aim of solving these problems by proposing a method essentially characterized in that it furthermore comprises:
a measurement step consisting in measuring the real position of the finish relative to a reference position;
a control step consisting in emitting a signal representing the offset between the real position and the reference position; and
a repositioning step consisting in applying a relative movement between the finish and the viewing means, so that the optical axis passes through the center of the finish.

The viewing step is carried out by viewing means then positioned with reference to the article, and more precisely with reference to the position of the finish of the article.
In the preferred embodiment, the viewing means are mounted to be mobile in relation to the article. By way of an alternative, the article is mounted to be mobile in relation to the viewing means, and in a third embodiment the viewing means and the article are both mounted to be mobile, each of these three embodiments enabling relative movement between the viewing means and the article, i.e. its finish.

In one embodiment, the viewing means are translationally mobile in a horizontal plane parallel to the plane of the conveyor. In another embodiment, the viewing means may furthermore be mobile on a vertical axis. In this embodiment, the device according to the invention is advantageously equipped with means for retracting the viewing means, in particular when these are moved along the vertical axis.

Thanks to the relative repositioning through servo-control of the measurement means relative to the real position of the finish, the optical axis of the viewing means passes through the center of the finish, which guarantees optimum detection.

In one embodiment, the step of processing the view includes a prior step consisting in unrolling the view and angularly resetting in relation to a reference mark.

This embodiment is particularly advantageous for articles provided with a threaded finish.

The step of processing the view preferably comprises, in addition, a masking step aiming to eliminate the optical signature of a natural reflection in the detection of the optical signature of a defect.

The method according to the invention can be employed for rotational articles as well as for shaped articles.

The invention also relates to a device for detecting defects in a finish of a glass article, comprising:
means for viewing a sample of the finish, provided with an optical axis; and
analysis means configured for automatic detection of an optical signature of a defect from the view.

The device according to the invention is essentially characterized in that it furthermore comprises:
means for measuring the offset between the real position of the finish and a reference position;
control means for emitting a signal representing the measured offset; and
repositioning means for applying a relative movement between the article and the viewing means depending on the measured offset, so that the optical axis passes through the center of the finish.

The device according to the invention is advantageously configured to implement the method according to the invention.

Advantageously, the solution according to the invention eliminates the need to use specific samples of defects in order to parameterize the device implementing the method.

The solution according to the invention may be advantageously applied to cork finishes as well as to threaded finishes, by angular reset.

In one embodiment, the viewing means comprise a light source and a plurality of output optical fibers, each of which is configured respectively to transmit the image of a given area (Z1, Z2, . . . Zi) of the finish at a predetermined angle.

In one embodiment, the light source is connected to a plurality of input optical fibers, each of which is configured in order to illuminate the finish at a predetermined angle of incidence.

In one embodiment, the input fibers and the output fibers are all provided with a color filter and set up so that the light emitted by an input fiber through a filter of a first color is essentially detected by an output fiber provided with a filter of a color identical to the first.

In an alternative embodiment, the combination of colors used for the filters may be replaced by particular polarization angles.

In one embodiment, the viewing means comprise a light source and a peripheral assembly of at least one mirror, the peripheral assembly being configured to transmit the image of a given area (ZR) of the finish corresponding to all or part of the circumference of the finish by means of an optical return device.

In one embodiment, the means for processing the image of a given area (ZR) of the finish comprise means configured to carry out to unroll the image and angularly reset this in relation to a reference marker.

The analysis means are preferably configured to detect automatically an optical signature of the defect comprising masking means aiming to eliminate the optical signature of a natural reflection in detecting the optical signature of a defect.

Thanks to these provisions, manual re-sorting is greatly reduced.

Furthermore, the time for adjusting devices employing the method according to the invention is greatly reduced. In addition, as the detection of defects is done without physical contact, the measurement rate is higher than that of devices that rotate the article.

The solution according to the invention may be employed in particular for glass articles used in the fields of perfumery, cosmetics, wines and spirits and food products.

### BRIEF DESCRIPTION OF THE DRAWINGS

Further characteristics and advantages of the present invention will become more clearly apparent on reading the following description, provided by way of illustrative and nonlimiting example and with reference to the appended figures in which:

FIG. 1 shows a diagram viewed from above of the device according to an embodiment of the invention; and

FIG. 2 shows a diagram of an embodiment of viewing means according to the invention.

### DETAILED DESCRIPTION OF THE PREFERRED EMBODIMENTS

Two types of shape of the body of articles and two types of shape of finish are conventionally distinguished. When an article has a shape generated by rotation, it is said to be “rotational”, otherwise it is said to be “shaped”. When a ring has a shape generated by rotation, it is called a cork finish, otherwise it is called a threaded finish.

As described further below, the solution according to the invention enables detection of defects independently of the shape of the article or its finish.

A surface crack is a microfissure that generates a reflection at the air/glass interface thus created. In order best to detect this type of defect, the solution according to the invention consists in optimally positioning illumination means.

To this end, the illumination means are positioned at various angles, i.e. various angles of incidence between an incident ray of light and the surface crack, so as to multiply the possible detection configurations. Similarly, the detection means are positioned at various angles.

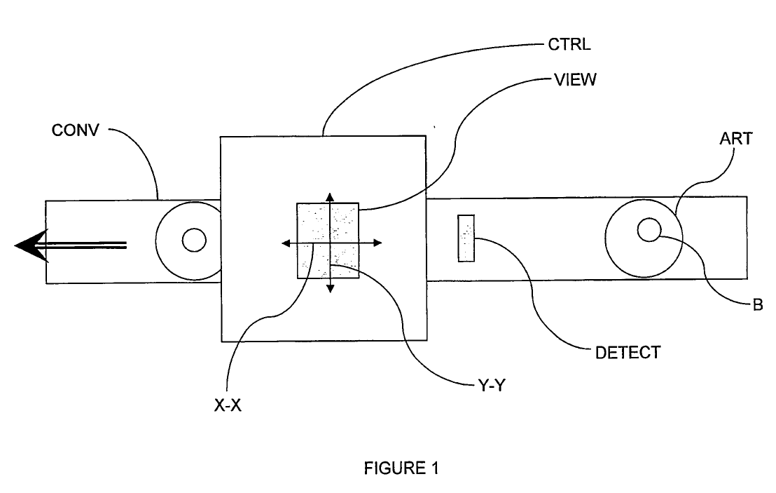

With reference to FIG. 1, glass articles ART, for example bottles, are arranged vertically on transport means CONV such as a conveyor.

In the embodiment shown in FIG. 1, the conveyor is a conveyor belt, at least part of which is linear and the direction of which is illustrated by the double arrow in the direction X-X. In another embodiment described below, the conveyor is a carrousel.

The glass articles ART are provided with a finish B in their upper part. In order to illustrate the phenomenon of glass tolerances, the finish B of the rotational article shown in FIG. 1 is excessively eccentric.

The presence of articles on the conveyor is detected, upstream of the viewing, by detection means DETECT. These detection means enable, in particular, the triggering of the subsequent viewing with a view to checking for the presence of defects to be controlled. The detection means are preferably joined to the supporting structure of the conveyor.

Furthermore, the device comprises measurement means, possibly coupled with the detection means. The measurement means are configured to measure the real position of the finish relative to a reference position, for example through an image from above of the article and processing by computer means of the image obtained. Other measurement means may be envisaged, for example telemetric means carrying out lateral measurements.

The measurement means for measuring the real position preferably comprise a camera providing an image of the article, image processing means configured for extracting the geometrical coordinates of the article and/or its finish.

In the preferred embodiment, the principle for measuring the real position is based on methods of shape recognition by an image-correlation algorithm.

To this end, a camera takes an image of the article viewed from above. The image of the finish has been saved beforehand as a reference. An area corresponding to the region of the image in which the finish might be situated is defined as the search area.

The reference model is superposed on the image in order to calculate a level of similarity, the correlation algorithm consisting in searching for maximum in similarities. The whole of the search area is explored by scanning. The maximum similarity level is considered valid if this exceeds an acceptability threshold.

The difficulties for this type of application are the lack of image stability from on image of an article to the next. Visible reflections at the base, the edge or at the surface of the finish are highly dependent on the geometry of the article. Yet, this geometry fluctuates and cannot be overcome as it is inherent in the method of manufacture of glass articles by blowing.

In order to minimize these phenomena, image processing is carried out by filters known by the name of mathematical morphology, enabling the image to be homogenized without impairing the geometry.

A servo-control device controlling, for each passing article, the position at which the viewing means must be situated to provide the best measurement for checking communicates with the means for measuring the real position.

To this end, repositioning means act, preferably, on the viewing means. In other embodiments, these repositioning means may act on the article and/or on the conveyor. The repositioning means are therefore configured to act on at least one of the elements comprising the assembly: viewing means, article, and conveyor.

The reference position for the measurement of the possible offset of the finish is defined, for example, by a reference article or alternatively by an absolute position. The means for measuring the offset are preferably joined to the supporting structure of the conveyor.

The real position of the finish is transmitted to the viewing means. The signal representing the offset between the real position and the reference position is transmitted, for example, in the form of a command to the repositioning means, configured to reposition the viewing means precisely in relation to the finish of the article to be checked.

Thus the measurement means enable the separation between the real position of the finish and a reference position to be measured and the value of this separation is transmitted to the checking means by a signal representing the measured offset. This signal transmission may be cabled or wireless.

Furthermore, the device according to the invention comprises checking means CTRL. The checking means comprise viewing means VIEW. Depending on the measured offset, the viewing means are repositioned relative to the finish of the article. The repositioning allows the optical axis of the viewing means to pass through the center of the finish, which guarantees optimal lighting and analysis conditions.

The repositioning of the viewing means is preferably carried out by a servo-system along the axis Y-Y, perpendicular to the direction of the conveyor. It is possible, however, also to provide servo-control of the relative movement in addition along the axis X-X of movement of the articles, for example in the case in which instantaneous viewing is carried out with articles stationary for the viewing. Likewise, depending on the height of the articles and their finishes, it is possible also to servo-control the relative movement in addition along the vertical axis Z-Z. A combination of the three repositionings is obviously conceivable.

For the sake of clarity, only the embodiment in which the repositioning of the viewing means is carried out by translational movement thereof along an axis Y-Y, transverse to the conveyor, is described here.

To this end, the viewing means are mounted on two lateral rails, joined to the supporting structure of the device. The rails enable the viewing means to slide in a direction transverse to the direction of the conveyor. The movement, with a view to repositioning, is ensured, for example, by rotation of a screw under the action of a motor.

The travel of the repositioning is determined by the preceding measurement of the offset between the real position of the finish and its reference position by the detection and offset-measurement means.

In another embodiment, the viewing means may also be mounted to be rotationally mobile about the optical axis.

The checking means are preferably joined to the supporting structure of the conveyor.

In the preferred embodiment, shown in FIG. 1, the conveyor is essentially linear and other types of checking may of course be carried out at other stations along the conveyor.

In another embodiment (not shown), the conveyor comprises a rotating plate. This type of conveyor is advantageously used for rotational objects. The article is loaded on an indexed rotating plate (carrousel) comprising several cells and positions. The whole plate is driven by a rotational movement allowing each cell to be positioned in a series of stations corresponding to various operations, one of which corresponds to the checking according to the invention. To this end, each station of the carrousel may be equipped with accessories enabling a given type of checking to be carried out. By way of example, the following checks can be cited: bore diameter, sealing, area of the finish, surface cracks in the finish, thickness of the body.

Some of these checks are carried out by rotating the article. To this end, a set of rollers in contact with the sides of the article enables the article to be rotated through friction. This type of check is of course only possible on articles with a rotationally symmetric shape.

Once the viewing means have been repositioned relative to the real position of the finish of the article, the viewing means produce a view of a sample of the finish. As described hereafter, the sample may be partial or complete.

The viewing means comprise a light emission/reception system. The light emission is produced by a light source. The light source may be single or multiple, for example a light-emitting diode (LED) assembly.

In a first embodiment (not shown), the emission of light is directable, for example by a set of input optical fibers connected to the source and each of which is configured to illuminate the finish at a determined angle of incidence.

The light reception means (detectors) also comprise a set of photoreceivers, for example around 20, suitably positioned. The photoreceivers are preferably image-transfer output optical fibers, each enabling transfer of a given area Z1, Z2 . . . Zi that is a fraction of the finish of the article.

Depending on the angle of incidence of a light ray on a surface crack, detection of the latter is enhanced as a function of the angle of the receivers. The relative orientation of receivers and emitters therefore allows the detection of a given type of surface crack to be enhanced.

In this embodiment, when the article is rotated (about its rotational axis) for the checking operation, the surface crack is found at one moment at such an angle in relation to one of the light sources that a large reflection is generated and a light peak is easily detected by one of the photoreceivers. This embodiment is particularly suited to rotational articles.

In an alternative embodiment, the article is not rotated for the checking operation. A fixed assembly of emitters and receivers, mounted on a support, gathers a plurality of partial images which are then processed by computer means aiming to eliminate the interfering reflections due to the faces of the finish for rotational finishes, and to the pitch of the thread for threaded finishes.

In one embodiment, the input fibers and the output fibers are furthermore all provided with a color filter and set up so that the light emitted by an input fiber through a filter of a first color is essentially detected by an output fiber provided with a filter of a color identical to the first. In this embodiment, if an input fiber faces an output fiber, they are provided with different color filters so as to avoid direct glare.

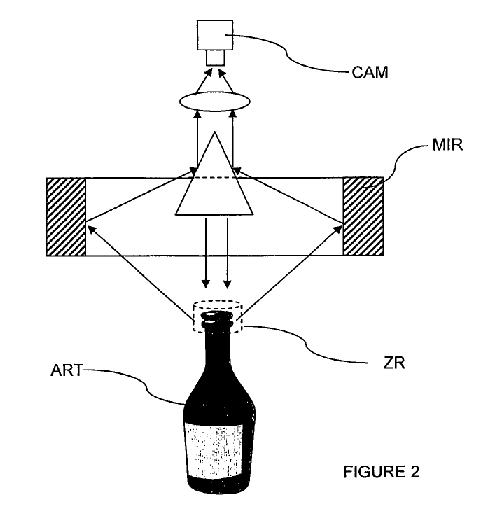

In a second embodiment, shown in FIG. 2, the viewing means comprise and optical head (not shown) provided with diffuse illumination , preferably positioned on the optical axis and configured to illuminate a glass article from above, and optical imaging means using an optical reflection of the image obtained of the illuminated article by a peripheral mirror MIR that has rotational symmetry and forms the image onto a camera CAM. The light emission/reception assembly is preferably rotationally symmetric.

By way of an alternative, the single peripheral mirror allowing a peripheral image of the finish to be obtained may be replaced by a circular assembly of facet mirrors juxtaposed with one another.

The mirror or the mirror assembly are preferably circular and the center of symmetry of these reflection means coincides with the center of symmetry of the finish of the article. The image of the finish is reflected toward a camera by means of an optical reflection device such as a reflective cone positioned along the optical axis, as shown in FIG. 2.

In FIG. 2, the arrows represent the optical path from the source (not shown) to the camera. Optical focusing means, such as a lens, may be mounted upstream of the camera.

In another embodiment, the illumination and detection means are lateral.

In one embodiment, the device according to the invention comprises several viewing means and/or several processing means configured to detect automatically an optical signature of a defect. Several types of defect may thus be detected by a single device.

The viewing means, i.e. the illumination means and the means for detecting reflections, are preferably mounted to be translationally mobile and are joined to each other.

A measurement device, such as a video camera or an optical sensor, retrieves the images of the article to be checked and communicates them to analysis means. This measurement device is preferably positioned nearby and may be mounted in a fixed manner.

In a first embodiment, the analysis mean are configured to detect automatically an optical signature of a defect. However, the drawback with optical fibers is that the images produced by the receiver assembly only allow construction of a partial image of the finish of the article being checked. Interpretation of the results is hence more difficult.

In a second embodiment, the analysis means are furthermore configured to process the images coming from the viewing means when these communicate a complete sample of the finish through a mirror assembly. In this case, the analysis means unroll the image so as to produce a flat image of all or part of the finish. The possible angular offset due to the random angular position of the article on the conveyor is compensated for by an angular reset step. This step is carried out by virtue of a reference mark preferably located on the article.

Whatever the embodiment, the analysis means comprise masking means that aim to eliminate the optical signature of a natural reflection and allow the automatic detection of the optical signature of a defect.

The masking operation enables, to this end, a natural reflection not to be associated with a defect, the optical signature of which is also a reflection.

The variations in position of the reflection (natural or defect) in the image of the viewer is in a direct relation with the position, especially the angular position, of the article below the viewing means. In the case in which the checked article does not have exactly the same position, reflections will appear at a different position. To avoid erroneous detection, the operator is required to enlarge the mask, which accordingly reduces the possibilities of detection.

This problem is solved by the second embodiment, which includes a step of unrolling the image. This embodiment enables the distinction between natural reflection and a defect to be made whatever the angular position of the threaded finish, due to the angular reset operation in relation to a reference mark.

To this end, in the case in which the article to be checked has a threaded finish, the reference mark may, for example, be the start of the pitch of the thread or a mark on the article (especially on the finish) such as the seam. The detection of an optical signature of the defect is produced by means of a masking operation, aiming to detect the absence of a light signal or the presence of a light signal over a given area of the image obtained by the viewing means so as to eliminate the optical signature of a natural reflection in the search for the optical signature of a defect.

The construction of a mask may be carried out in the following manner:
in a first period, a test is carried out using non-defective articles constantly brought into a given angular position, then defective articles brought into the same angular position; and
in a second period, the same test is carried out with random transverse positions of the articles on the conveyor, within a limit that is more or less the diameter of the finish.

The first period is carried out for a maximum number of given angular positions.

The steps of the method according to the invention are preferably sequential: detection of the presence of an article, measurement of the offset of the finish, repositioning of the viewing means, then automatic viewing and analysis of an optical signature. By way of example, the delay between each phase may be of the order of 250 ms.

Depending on the speed of the overall device implementing the invention, the steps may be interleaved, i.e., for example, the detection of a new article may be carried out before the analysis of the optical signature of the preceding article on the conveyor has been finished.

Thanks to the invention, any type of article may be processed.

Rotational articles may be checked in a device such as a carrousel, and shaped articles on a linear conveyor.

For articles provided with a cork finish, viewing means comprising a plurality of optical fibers may be used.

For articles with a threaded finish, viewing means comprising a peripheral mirror may be used in combination with analysis means configured to carry out an unrolling and an angular reset of the image obtained.

1-10. (canceled)

11. A method for detecting a defect in a finish of a glass article, comprising the steps of:
viewing an image of a sample of the finish by viewing means comprising an optical axis;
processing a view by analysis means configured to detect an optical signature of the defect automatically;
measuring a real position of the finish relative to a reference position;
emitting a signal representing an offset between the real position and the reference position; and
applying a relative movement between the finish and the viewing means, so that the optical axis passes through a center of the finish.

12. The method as claimed in claim 11, wherein the step of processing the view includes a prior step comprising unrolling the view and angularly resetting in relation to a reference mark.

13. The method as claimed in claim 11, wherein the step of processing the view further comprises a masking step aiming to eliminate the optical signature of a natural reflection in the detection of the optical signature of a defect.

14. A device for detecting defects in a finish of a glass article, comprising:
means for viewing a sample of the finish, provided with an optical axis;
analysis means configured for automatic detection of an optical signature of a defect from a view;
means for measuring an offset between a real position of the finish and a reference position;
control means for emitting a signal representing the measured offset; and
repositioning means for applying a relative movement between the glass article and the viewing means depending on the measured offset, so that the optical axis passes through a center of the finish.

15. The device as claimed in claim 14, wherein the viewing means comprises a light source and a plurality of output optical fibers, each of which is configured respectively to transmit an image of a given area Z1, Z2, . . . Zi of the finish at a predetermined angle.

16. The device as claimed in claim 15, wherein the light source is connected to a plurality of input optical fibers, each of which is configured in order to illuminate the finish at a predetermined angle of incidence.

17. The device as claimed in claim 16, wherein the input fibers and the output fibers are all provided with a color filter and set up so that light emitted by an input fiber through a filter of a first color is essentially detected by an output fiber provided with a filter of a color identical to the first color.

18. The device as claimed in claim 14, wherein the viewing means comprises a light source and a peripheral assembly of at least one mirror, the peripheral assembly being configured to transmit the image of a given area ZR of the finish corresponding to all or part of a circumference of the finish by means of an optical return device.

19. The device as claimed in claim 18, further comprising means for processing the image of a given area ZR of the finish and said image processing means comprising means for carrying out unrolling of the image and angularly reset the image in relation to a reference marker.

20. The device as claimed in claim 14, wherein the analysis means are configured to detect automatically an optical signature of the defect and comprise masking means for aiming to eliminate an optical signature of a natural reflection in detecting the optical signature of a defect.
